(19) United States
(12) Patent Application Publication
(10) Pub. No.: US 2015/0240789 A1
(43) Pub. Date: Aug. 27, 2015

(54) METHOD OF ANALYZING WAKE FLOW OF WIND TURBINE BASED ON MULTIPLE WAKE FLOW MODELS

(71) Applicants: State Grid Corporation of China, Beijing (CN); Gansu Electric Power Company of State Grid, Lanzhou (CN); Wind Power Technology Center of Gansu Electric Power Company, Lanzhou (CN)

(72) Inventors: LIANG LU, Beijing (CN); NING-BO WANG, Beijing (CN); WEN-LING JIANG, Beijing (CN); ZI-FEN HAN, Beijing (CN); LONG ZHAO, Beijing (CN); DING-MEI WANG, Beijing (CN); GUANG-TU LIU, Beijing (CN); QING-QUAN LV, Beijing (CN); ZHAO CHEN, Beijing (CN)

(21) Appl. No.: 14/619,078

(22) Filed: Feb. 11, 2015

(30) Foreign Application Priority Data
Feb. 25, 2014 (CN) 201410064885.1

(51) Int. Cl. F03D 11/00; G01P 5/06

(52) U.S. Cl. CPC F03D 11/0091; G01P 5/06

(57) ABSTRACT

A method of analyzing wake flow of wind turbine based on multiple wake flow models includes following steps. A number of wake flow model are analyzed. A number of wake flow turbulence models are analyzed based on analysis results of the wake flow models. A number of wake flow combined models are analyzed based on the analysis results of the wake flow turbulence models, and the wind turbine wake flow analysis results of all the wake flow models, wake flow turbulence modes, and wake flow combine models are obtained.

This application claims all benefits accruing under 35 U.S.C. §119 from China Patent Application 201410064885.1 filed on Feb. 25, 2014 in the China Intellectual Property Office, disclosure of which is incorporated herein by reference.

### BACKGROUND

1. Technical Field

The present disclosure relates to a method of analyzing wake flow of wind turbine based on multiple wake flow models.

2. Description of the Related Art

With the rapid development of wind power industry, China has entered a period of rapidly developing wind power. Large-scale wind power bases are usually located in the “Three North” (Northwest, Northeast, Northern China) of China. The large-scale wind power bases are far away from the load center, thus their electricity need being delivered to the load center for over long distances.

Because of the intermittent, randomness, and volatility of the wind resource, the wind power output from the large-scale wind power base will fluctuate in a wide range. Therefore, the charging power of the transmission network will also fluctuate, which brings a series of problems to the security of power grid. The wake flow of wind turbine also has an impact on operation conditions of the wind farm.

What is needed, therefore, is a method of analyzing wake flow of wind turbine based on multiple wake flow models.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a flow chart of one embodiment of a method of analyzing wake flow of wind turbine based on multiple wake flow models.

FIG. 2 shows a schematic view of one embodiment of an effect of multiple wake flow in the method of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

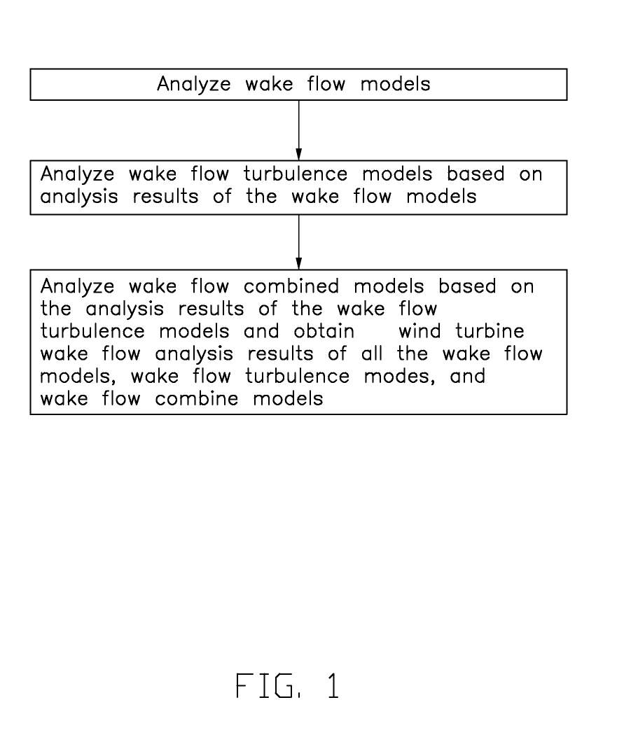

Referring to FIG. 1, a method of analyzing wake flow of wind turbine based on multiple wake flow models comprises:

step (a), analyzing wake flow models;

step (b), analyzing wake flow turbulence models based on analysis results of the wake flow models; and

step (c), analyzing wake flow combined models based on the analysis results of the wake flow turbulence models and obtaining wind turbine wake flow analysis results of all the wake flow models, wake flow turbulence modes, and wake flow combine models.

In step (a), the wake flow model can adopt Larsen model which is an asymptotic expression based on the Prandtl boundary layer equation. The wake flow model is an analytical model.

Assuming that wind speed attenuations at different positions in downwind side are similar, and the wind speed will be moderately declined, thus the affected area of the wake flow at L=x in downwind side can be calculated by:

$$\{ \begin{matrix}{R}_{w} = {{{[ \frac{35}{2 π} ]}^{\frac{1}{5}} [ 3 {c}_{1}^{2} ]}^{\frac{1}{5}} [ {C}_{T} Ax ]}^{\frac{1}{3}} \\ {c}_{1} = {l ( {C}_{T} Ax )}^{- \frac{1}{3}}\end{matrix} ; \qquad ( 1 )$$

wherein c₁ is a dimensionless mixing length, l is a Prandtl mixing length, A is a swept area of the wind turbine, and C_{T} is a thrust coefficient of wind turbine.

C₁ can be calculated in engineering by following formula in order to avoid counting Prandtl mixing length:

$${c}_{1} = {[ \frac{D}{2} ]}^{- \frac{1}{2}} {( {C}_{T} {Ax}_{0} )}^{- \frac{5}{6}} ; \qquad ( 2 )$$

wherein x₀ is an approximated parameter, and can be calculated by:

$${x}_{0} = \frac{9.5 D}{{( \frac{2 {R}_{9.5}}{D} )}^{3} - 1} ; \qquad ( 3 )$$

wherein R_{9.5} can be determined by:

$$\{ \begin{matrix}{R}_{9.5} = 0.5 [ {R}_{nb} + min ( h , {R}_{nb} ) ] \\ {R}_{nb} = max [ 1.08 D , 1.08 D + 21.7 ( {I}_{a} - 0.05 ) ]\end{matrix} \qquad ( 4 )$$

wherein Iₐ is environmental turbulence intensity of the measurement point, and can be expressed as:

$${I}_{a} = \frac{{σ}_{u}}{{U}_{10}} \qquad ( 5 )$$

wherein σᵤ is wind speed standard deviation, and U₁₀ is the average value of the wind speed during 10 minutes.

Furthermore, while lacking of measurement data, the environmental turbulence intensity can be approximated expressed by:

$${I}_{a} = λ κ [ \frac{1}{ln [ z \text{/} {z}_{0} ]} ] \qquad ( 6 )$$

wherein λ ranges from about 2.5 to about 1.8, such as 1.0; κ=0.4 is the Karman constant, and z₀ is roughness.

The wind speed attenuation of the Larsen wake flow model can be expressed as:

$$Δ U = - \frac{{U}_{WT}}{9} {{( {C}_{T} {Ax}^{- 2} )}^{\frac{1}{3}} [ {{R}_{w}^{\frac{3}{2}} ( 3 {c}_{1}^{2} {C}_{T} Ax )}^{- \frac{1}{2}} - ( \frac{{35}^{\frac{3}{10}}}{2 π} {( 3 {c}_{1}^{2} )}^{- \frac{1}{5}} ) ]}^{2} \qquad ( 7 )$$

wherein U_{WT} is the average wind speed of wind measurement points.

In step (b), the affect of the wake flow to the environmental turbulence at downwind side should be added into the wake flow model. Larsen models can adopt simple empirical modes to reflect the wake flow affected area. Thus the wake flow turbulence intensity caused by the wake flow can be expressed as:

$${I}_{w} = 0.29 {S}^{- \frac{1}{3}} \sqrt{1 - \sqrt{1 - {C}_{T}}} \qquad ( 8 )$$

wherein I_{w} represents the turbulence intensity caused by the wake flow and named as wake flow turbulence intensity, S represents a distance between the wake flow turbulence and the wind turbine at the upwind side which is expressed through a diameter of impeller, and C_{T} is a thrust coefficient of wind turbine.

Furthermore, while the wake flow turbulence is an independent random variables, the total wake flow turbulence intensity at downwind side of anemometer tower can be expressed as:

Iₚₐᵣₖ=\sqrt{I_{ambient}²+I_{w}²} (9)

wherein I_{ambient} is the environmental turbulence intensity at downwind of anemometer tower which is undisturbed and corresponding to parameter Iₐ in Larsen model; Iₚₐᵣₖ is the total wake flow turbulence intensity. Thus the result of formula (9) can substitute environmental turbulence intensity Iₐ in formula (4) to embody the wind speed attenuation effect at the downwind position caused by the wake flow turbulence.

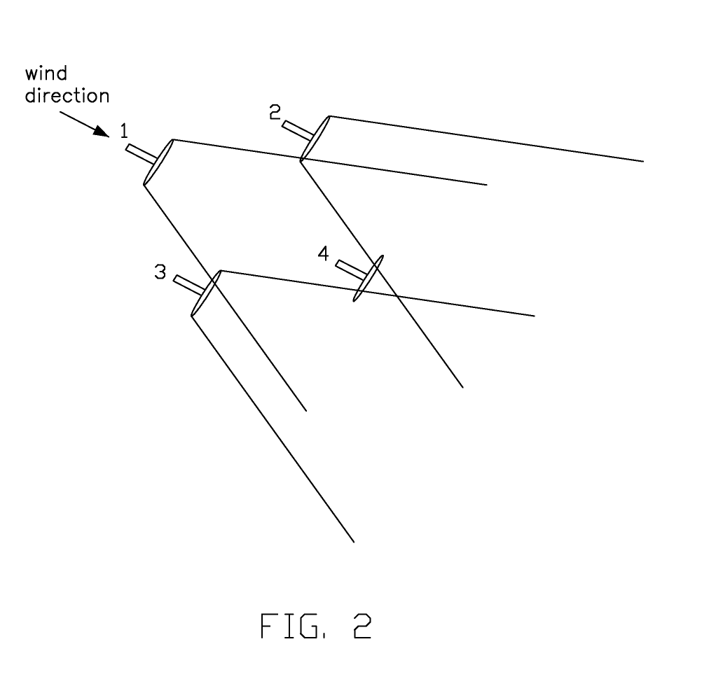

In step (c), the wake flow model in step (a) can be extended to obtain wake flow effect to the anemometer tower caused by a plurality of wind turbines at the upwind position. Because the wake flow model in step (a) adopt single model, which means that there is single wind turbine at the upwind position, the wake flow model in step (a) analyze the wake flow of single wind turbine. However, there are usually many wind turbines. Referring to FIG. 2, a fourth anemometer tower 4 is effected by a first anemometer tower 1, a second anemometer tower 2, and a third anemometer tower 3 at the same time.

The wake flow combined models can be obtained through square summation method and expressed as:

$$δ {U}_{n} = \sqrt{{\sum }_{k = 1}^{n - 1} {( δ {U}_{kn} )}^{2}} \qquad ( 10 )$$

wherein δU is wind speed attenuation at the anemometer tower located at downwind position of each of the plurality of wind turbines located at the upwind position; n is the number of wind turbines at upwind position, and n is a natural number.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A method of analyzing wake flow of wind turbine based on multiple wake flow models, the method comprising:
analyzing wake flow models;
analyzing wake flow turbulence models based on analysis results of the wake flow models; and
analyzing wake flow combined models based on the analysis results of the wake flow turbulence models and obtaining wind turbine wake flow analysis results of all the wake flow models, wake flow turbulence modes, and wake flow combine models.

2. The method of claim 1, wherein the wake flow model adopts Larsen model which is an asymptotic expression based on the Prandtl boundary layer equation, and the wake flow model is an analytical model.

3. The method of claim 1, wherein wind speed attenuations at different downwind positions are the same, wind speed is moderately declined, and affected area of the wake flow at L=x in downwind side is calculated by:
$$\{ \begin{matrix}{R}_{w} = {{{[ \frac{35}{2 π} ]}^{\frac{1}{5}} [ 3 {c}_{1}^{2} ]}^{\frac{1}{5}} [ {C}_{T} Ax ]}^{\frac{1}{3}} \\ {c}_{1} = {l ( {C}_{T} Ax )}^{- \frac{1}{3}}\end{matrix} ;$$
wherein c₁ is a dimensionless mixing length, l is a Prandtl mixing length, A is a swept area of the wind turbine, and C_{T} is a thrust coefficient of wind turbine.

4. The method of claim 3, wherein c₁ is calculated by following formula to avoid counting Prandtl mixing length:
$${c}_{1} = {[ \frac{D}{2} ]}^{- \frac{1}{2}} {( {C}_{T} {Ax}_{0} )}^{- \frac{5}{6}} ;$$
wherein x₀ is an approximated parameter.

5. The method of claim 4, wherein x₀ is calculated by:
$${x}_{0} = \frac{9.5 D}{{( \frac{2 {R}_{9.5}}{D} )}^{3} - 1} .$$

6. The method of claim 5, wherein R_{9.5} is determined by:
$$\{ \begin{matrix}{R}_{9.5} = 0.5 [ {R}_{nb} + min ( h , {R}_{nb} ) ] \\ {R}_{nb} = max [ 1.08 D , 1.08 D + 21.7 ( {I}_{a} - 0.05 ) ]\end{matrix} ;$$
wherein Iₐ is environmental turbulence intensity of measurement point.

7. The method of claim 6, wherein Iₐ is calculated by:
$${I}_{a} = \frac{{σ}_{u}}{{U}_{10}} ;$$
wherein σᵤ is wind speed standard deviation, and U₁₀ is the average value of the wind speed during 10 minutes.

8. The method of claim 6, wherein the environmental turbulence intensity is expressed by:
$${I}_{a} = λ κ [ \frac{1}{ln [ z \text{/} {z}_{0} ]} ] ;$$
wherein λ ranges from about 2.5 to about 1.8, κ=0.4 is the Karman constant, and z₀ is roughness.

9. The method of claim 8, wherein the wind speed attenuation of the Larsen wake flow model is expressed as:
$$Δ U = - \frac{{U}_{WT}}{9} {{( {C}_{T} {Ax}^{- 2} )}^{\frac{1}{3}} [ {{R}_{w}^{\frac{3}{2}} ( 3 {c}_{1}^{2} {C}_{T} Ax )}^{- \frac{1}{2}} - ( \frac{{35}^{\frac{3}{10}}}{2 π} {( 3 {c}_{1}^{2} )}^{- \frac{1}{5}} ) ]}^{2} ;$$
wherein U_{WT} is an average wind speed of wind measurement points.

10. The method of claim 9, wherein affect of the wake flow to the environmental turbulence at downwind side is added into the wake flow model, Larsen models adopt simple empirical modes to reflect the affect, and the wake flow turbulence intensity caused by the wake flow is expressed as:
$${I}_{w} = 0.29 {S}^{- \frac{1}{3}} \sqrt{1 - \sqrt{1 - {C}_{T}}} ;$$
wherein S represents a distance between the wake flow turbulence and the wind turbine at upwind side which is expressed through a diameter of impeller, and C_{T} is the thrust coefficient of wind turbine.

11. The method of claim 10, wherein the wake flow turbulence is an independent random variables, the total wake flow turbulence intensity at downwind side of anemometer tower is expressed as:
Iₚₐᵣₖ=\sqrt{I_{ambient}²+I_{w}²};
wherein I_{ambient} is the environmental turbulence intensity at downwind of anemometer tower which is undisturbed and corresponding to parameter Iₐ in Larsen model; Iₚₐᵣₖ is the total wake flow turbulence intensity.

12. The method of claim 11, wherein the wake flow model is extended to obtain wake flow effect to the anemometer tower caused by a plurality of wind turbines at the upwind side.

13. The method of claim 12, wherein the wake flow combined models is obtained through square summation method and expressed as:
$$δ {U}_{n} = \sqrt{{\sum }_{k = 1}^{n - 1} {( δ {U}_{kn} )}^{2}} ;$$
wherein δU is the wind speed attenuation at the anemometer tower located at downwind side of each of the plurality of wind turbines located at the upwind side; n is the number of wind turbines at upwind position, and n is a natural number.
